(19) United States
(12) Patent Application Publication
(10) Pub. No.: US 2015/0165377 A1
(43) Pub. Date: Jun. 18, 2015

(54) NOX SENSOR WITH AMOX CATALYST

(71) Applicant: Caterpillar Inc., Peoria, IL (US)

(72) Inventors: Eric L. Schroeder, Germantown Hills, IL (US); Sylvain J. Charbonnel, (US)

(73) Assignee: Caterpillar Inc., Peoria, IL (US)

(21) Appl. No.: 14/103,887

(22) Filed: Dec. 12, 2013

(51) Int. Cl. B01D 53/94

(52) U.S. Cl. CPC B01D 53/9459

(57) ABSTRACT

An exhaust system includes an catalytic oxidation device, an particulate trap, a mixer, and a selective reduction catalyst (SCR), an adapter, and a sensor. The SCR is disposed downstream of a mixing tube and reduces oxides of nitrogen in the exhaust gas stream. The oxides of nitrogen are reduced in presence of ammonia on the SCR. The exhaust system also includes an adapter with an inlet and outlet pipe. A sensor is disposed downstream of the SCR, between the inlet and outlet pipe. The sensor is configured to measure an amount of oxides of nitrogen in the exhaust gas stream. Further an ammonia oxidation (AMOX) catalyst is disposed, in the adapter, upstream of the sensor for oxidizing the residual ammonia that may slip through the SCR before the exhaust gas stream reaches the sensor.

### TECHNICAL FIELD

The present disclosure relates generally to an exhaust system and in particular to an exhaust treatment system with an ammonia oxidation catalyst associated with a nitrogen oxide (NOx) sensor.

### BACKGROUND

Exhaust treatment systems are used to remove undesirable constituents from the exhaust gas stream of fossil fuel powered systems (such as diesel engines, gas engines, gas turbines), which may be used to drive generators, commercial vehicles, machines, ships, locomotives and the like. Exhaust treatment systems may include a variety of emission treatment technologies, such as diesel oxidation catalysts (DOCs), diesel particulate filters (DPFs), selective catalytic reduction (SCR) catalysts or other devices used to treat the exhaust gas stream.

Selective catalytic reduction (SCR) systems are configured to remove oxides of nitrogen (NOx) emissions from the exhaust gas stream. In such systems, an SCR catalyst facilitates a reaction between a reductant and NOx to produce water and nitrogen gas as products, thereby removing NOx from the exhaust gas stream. Generally, the reductant can be mixed with the exhaust gas stream upstream of the SCR catalyst. The mixing of the reductant in the exhaust gas stream can be referred to as dosing of the exhaust gas stream.

Furthermore, sensors are positioned in the exhaust pipe to measure NOx levels at various points in the exhaust system. Sensor measurements taken downstream of the SCR catalyst may be used to calculate the conversion efficiency of the SCR catalyst. In other words, the NOx measured by the sensors can be used to determine the effectiveness of the SCR catalyst in converting the NOx to nitrogen gas (N2) and water (H2O). The measurement from the sensor acts as an input for controlling the dosing of the exhaust gas stream. A dosing control system controls the dosage of the reductant added to the exhaust gas stream in response to the NOx sensor readings downstream of the SCR catalyst.

In certain instances, due to high exhaust temperatures, unused reductant, such as ammonia, slips downstream of the SCR catalyst in the exhaust pipe. Higher levels of ammonia slip can cause wrong measurement by the sensors and interfere with the dosing control system.

### SUMMARY

In one aspect, an exhaust treatment system is provided. The exhaust treatment system comprises an optional catalytic oxidation device, an optional particulate trap, a mixing tube, a selective reduction catalyst, an adapter downstream of the selective reduction catalyst, and a sensor. The catalytic oxidation device can be configured to oxidize hydrocarbons, and oxides of carbon and nitrogen in an exhaust gas stream. The particulate trap may be configured to remove one or more types of particulate matter from the exhaust gas stream. Furthermore, the mixing tube can be configured to mix the exhaust gas stream with a reductant. The mixing tube can be further be configured to facilitate decomposition of the reductant into ammonia. The exhaust system also includes the selective reduction catalyst disposed downstream of the mixing tube. The selective reduction catalyst can be configured to reduce oxides of nitrogen using the ammonia. Furthermore, the exhaust system includes the adapter. The adapter is disposed downstream of the selective reduction catalyst. The adapter includes an inlet pipe and an outlet pipe. The inlet pipe and the outlet pipe are abutted to each other and are disposed in a direction of flow of the exhaust gas stream. Further, the system comprises the sensor. The senor can be configured to measure the amount of oxides of nitrogen in the exhaust gas stream. In an embodiment, the sensor is coated with an ammonia oxidation catalyst for oxidizing the ammonia present in the exhaust gas stream upstream of the sensor.

In another embodiment, the system comprises an adapter disposed downstream of the selective reduction catalyst. The adapter comprises an inlet pipe and an outlet pipe. Both the inlet pipe and the outlet pipe are abutted to each other and disposed in the direction of flow of the exhaust gas stream. Further, a sensor is disposed between the inlet pipe and the outlet pipe. The sensor is configured to measure the amount of oxides of nitrogen in the exhaust gas stream. In an embodiment, the inlet pipe of the adapter is coated with an ammonia oxidation catalyst for oxidizing the ammonia present in the exhaust gas stream upstream of the sensor.

In another embodiment, the inlet pipe of the adapter comprises a substrate. The substrate can be coated with an ammonia oxidation catalyst for oxidizing the ammonia present in the exhaust gas stream upstream of the sensor before the exhaust gas stream reaches the sensor.

### BRIEF DESCRIPTION OF THE DRAWINGS

FIG. 1 illustrates an exemplary exhaust system according to one embodiment of the present disclosure;

FIG. 2 illustrates an exemplary exhaust system with a NOx sensor according to one embodiment of the present disclosure; and

FIG. 3 illustrates an exemplary exhaust system with a NOx sensor according to one embodiment of the present disclosure.

### DETAILED DESCRIPTION

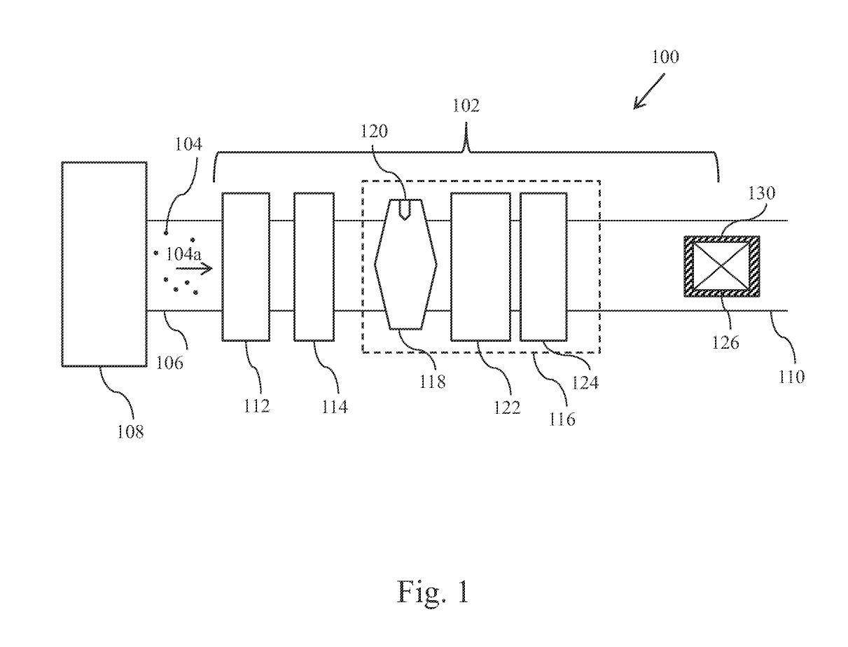

FIG. 1 illustrates an exemplary exhaust system 100. The exhaust system comprises an exhaust treatment system 102 for treating an exhaust gas stream 104. The flow of the exhaust gas stream is shown by an arrow 104a. The exhaust system 100 comprises an inlet exhaust conduit 106, an internal combustion (IC) engine 108, and an outlet exhaust conduit 110. The exhaust gas stream 104 can flow through the inlet exhaust conduit 106. In one embodiment of the disclosure, the exhaust gas stream 104 may be produced by the IC engine 108. Examples of the IC engine 108 may include a, marine diesel engine, a spark ignited engine, or any other type of engine that may be operated with an excess of oxygen. Further, the IC engine 108 may operate in either a stationary role (e.g., power plants, generators, etc.) or in a mobile capacity (e.g., vehicles, moving equipment, etc.). As a common trait of many engines, excess oxygen present during combustion may yield oxides of nitrogen (NOx) in the exhaust gas stream 104. The exhaust treatment system 102 converts at least a part of the NOx from exhaust gas stream 104 into more benign compounds such as nitrogen gas (N2), carbon dioxide (CO2), and water vapor, for example. These compounds may then be expelled into the atmosphere through an outlet exhaust conduit 110.

A block diagram of the exhaust treatment system 102 is further described in FIG. 1 according to an embodiment of the disclosure. The exhaust treatment system 102 for treating the exhaust gas stream can be configured to remove undesirable emissions from the exhaust gas stream 104 of the IC engine 108. The system exhaust treatment 102 may include a variety of emission treatment technologies, including, but not limited to, regeneration devices, heat sources, oxidation catalysts, diesel oxidation catalysts (DOCs), diesel particulate filters (DPFs), selective catalytic reduction (SCR) device, mufflers, or other devices that may be required to treat the exhaust gas exiting the IC engine 108. In an embodiment, the exhaust treatment system 102 includes a DOC 112, a DPF 114, and a SCR device 116, as shown in FIG. 1. Although, the DOC 112, DPF 114, and the SCR device 116 are shown to be in a series arrangement, the order, layout, arrangement, and the type of devices included in the exhaust treatment system 102 may vary in other embodiments.

The DOC 112 may be configured in a variety of ways and contain catalyst materials useful in collecting, absorbing, adsorbing, and/or converting hydrocarbons, carbon monoxide, and/or oxides of nitrogen contained in the exhaust. Such catalyst materials may include, for example, aluminum, platinum, palladium, rhodium, barium, cerium, and/or alkali metals, alkaline-earth metals, rare-earth metals, or combinations thereof. The DOC 112 may include, for example, a ceramic substrate, a metallic mesh, foam, or any other porous material known in the art, with the catalyst materials located on the substrate of the DOC 112. The DOC 112 assists in oxidizing one or more components of the exhaust gas stream, such as, for example, particulate matter, hydrocarbons, and/or carbon monoxide. The DOC 112 may also be configured to oxidize NO contained in the exhaust gas, thereby converting it to NO2.

The DPF 114 may be configured in a variety of ways. Any structure capable of removing particulate matter from the exhaust of the engine 12 may be used. For example, the DPF 114 may include a wall-flow ceramic substrate having a honeycomb cross-section constructed of cordierite, silicon carbide, or any other material suitable to remove particulate matter. In an embodiment, the exhaust treatment system 102 may omit the DOC 112 and/or the DPF 114. In other words, the system 102 may include the SCR device 116.

The SCR device 116 may be configured in a variety of ways to catalytically convert NOx gases into nitrogen gas and water. In an embodiment, the SCR device 116 can include a mixing tube 118, a reductant injector 120, a selective reduction (SCR) catalyst 122, and an optional ammonia oxidation catalyst 124. The mixing tube 118 can be configured to mix the exhaust gas stream 104 with a reductant and facilitate decomposition of the reductant into ammonia. The mixing tube 118 can be fluidly connected with the reductant injector 120. The reductant injector 120 can be configured to spray a reductant into the exhaust gas stream 104 flowing through the mixing tube 118. A gaseous or liquid reductant, in general a water or urea solution, ammonia gas, liquefied anhydrous ammonia, ammonium carbonate, an amine salt, or a hydrocarbon such as diesel fuel, may be sprayed or otherwise advanced by the reductant injector 120 into the exhaust gas stream 104 passing through the mixing tube 118. For example, the reductant injector 120 may be disposed at any desired distance upstream of the SCR catalyst 122 to allow the injected reductant sufficient time to mix with exhaust and to sufficiently decompose into ammonia before entering the SCR catalyst 122. In an exemplary embodiment, an even distribution of sufficiently decomposed reductant within the exhaust may enhance NOx reduction therein. To enhance incorporation of the reductant with the exhaust, the mixing tube 118 may include vanes or blades, inclined at an angle, to generate a swirling motion of the exhaust gas as it flows through the mixing tube 118. In an alternate embodiment, SCR device 116 may omit the mixing tube 118. It can be contemplated, the mixing tube 118 can be a separate component disposed upstream of the SCR device 116.

In an embodiment, the exhaust gas stream 104 with the decomposed reductant for example, NH3 (ammonia) passes through the SCR catalyst 122. The SCR catalyst 122 can be a suitable catalyst, such as, a vanadium and titanium based, a platinum-type, or a zeolite-type catalyst. The SCR catalyst 122 can also include a metallic or ceramic honeycomb flow-through substrate or any other structure infused with one or more metals capable to assist in reduction of NOx. For example, the SCR catalyst 122 can include metallic or ceramic foam, a wire mesh, or any other suitable material coated with a ceramic material such as titanium oxide, a base metal oxide such as vanadium and tungsten, zeolites, and/or a precious metal. The SCR catalyst can also include an extruded catalyst where the support material is made of the catalyst itself With this composition, decomposed reductant entrained within an exhaust gas stream 104 flow passing through the SCR catalyst 122 may be absorbed onto the surface of and/or internalized with SCR catalyst material, where the reductant may react with NOx (NO and/or NO2) in the exhaust gas stream 104 to form water (H2O) and diatomic nitrogen (N2).

The oxides of nitrogen (NOx) react with ammonia in the presence of the SCR catalyst 122 and are converted to water (H2O) and diatomic nitrogen (N2). In order to ensure sufficient NOx reduction, the exhaust gas stream 104 can be sprayed with excess quantity of reductant. Thus, after passing through the SCR catalyst 122, the exhaust gas stream may include some amount of unused ammonia. To prevent this ammonia from being released into the atmosphere, the exhaust gas stream 104 can be made to pass through different catalyst, such as an optional catalytic oxidation device or an optional ammonia oxidation (AMOX) catalyst 124. In an embodiment the optional AMOX catalyst 124 can be disposed downstream of the SCR catalystl22. The optional AMOX catalyst 124 may include any suitable substrate coated with or otherwise containing a catalyzing material, for example, a precious metal that catalyzes a chemical reaction to alter a composition of exhaust gas passing through the oxidation catalyst. In one embodiment, the optional AMOX catalyst 124 may include palladium, platinum, vanadium, or a mixture thereof that facilitates oxidation of unused ammonia gas and/or entrained reductant. Such optional AMOX catalyst 124 may also facilitate the oxidation of NO in the exhaust to NO2. In another embodiment, the optional AMOX catalyst 124 may alternatively or additionally perform particulate trapping functions, hydrocarbon oxidation functions, carbon monoxide oxidation functions, and/or other functions known in the art. For example, the optional AMOX catalyst 124 may include an optional particulate trap such as a continuously regenerating technology particulate filter or a catalyzed continuously regenerating technology particulate filter. In an alternate embodiment, the SCR device 116 may omit the optional AMOX catalyst 124. In can be contemplated that the SCR device 116 may omit the optional AMOX catalyst 124 and the exhaust gases with unused ammonia may flow downstream of the SCR catalyst 122. In other words, the exhaust treatment system 102 may not include the optional AMOX catalyst 124 and the exhaust gases may directly flow downstream the SCR catalyst 122.

In an embodiment, the exhaust treatment system 102 may also include at least one sensor 126 disposed to monitor operating characteristics and/or other parameters of the exhaust treatment system 102. For example, the sensor 126 may be utilized to detect a constituent of the exhaust gas stream 104 downstream the SCR catalyst 122, such as, a concentration of NOx. In an embodiment, the sensor 126 can be a NOx sensor 126 (herein after referred as NOx sensor 126) disposed downstream the optional AMOX catalyst 124 and or the SCR catalyst 122. The NOx sensor 126 can be configured to determine the concentration of NOx or an amount of oxides of nitrogen or unused reductant in the exhaust gas stream 104. The NOx sensor 126 may generate a signal indicative of constituent concentration of the exhaust gas stream 104. The signal may be utilized by a control system , for example a dosing control system 128 to determine, among other things, a quantity of reductant to be sprayed by the reductant injector 120. In other words, the quantity of reductant varies the amount of ammonia, and hence controls the reduction at the SCR catalyst 122. Thus, determining the amount of reductant or the oxides of nitrogen can limit the amount of NOx released in the atmosphere. For example, certain emission guidelines, such as defined by the IM03 marine emissions guidelines, may provide a threshold limit for constituents of exhaust gases that can be released to the atmosphere. Hence, the amount of the reductant added to exhaust gas stream can be varied based on the measurement by the oxides of nitrogen measured by the NOx sensor 126.

In an embodiment, the exhaust treatment system 102 comprises an AMOX catalyst 130. In one embodiment, the AMOX catalyst 130 may be provided as a coating on the NOx sensor 126. The AMOX catalyst 130 may be configured to oxidize the residual ammonia present in the exhaust gas stream 104 that has slipped though the optional AMOX catalyst 124 or present downstream the SCR catalyst 122 where the optional AMOX catalyst 124 is omitted. In other words, the AMOX catalyst 130 may be used to oxidize the unused ammonia that may have slipped into the exhaust gas stream 104 beyond the SCR catalyst 122. The AMOX catalyst 130 oxidizes the slipped ammonia in the exhaust gas stream before it reaches the NOx sensor 126.

In certain conditions, where the optional AMOX catalyst 124 can be omitted, the unused reductant in the exhaust gas stream 104 may pass through the SCR catalyst 122. The passing of the unused ammonia may be referred to as ammonia slip. The residual ammonia or ammonia slip may trigger the NOx sensor 126 to indicate NOx higher than the actual value of NOx from the IC engine 108. Accordingly, the dosing control system 128 commands to spray more reductant in the exhaust gas stream. This further leads to increase in residual ammonia in the exhaust gas stream 104 downstream of the SCR catalyst 122. Hence, the dosing control system may “run away” and continue to spray more reductant hence more ammonia. To prevent this, the unused ammonia in the exhaust gas stream may be oxidized by using the AMOX catalyst 130. In an embodiment, the AMOX catalyst 130 can be similar to the optional AMOX catalyst 124. In another embodiment, the AMOX catalyst 130 can be different from the optional AMOX catalyst 124. Hence, the AMOX catalyst 130 provides for a functioning of the dosing control system 128, the SCR device 116, and accurate measurement of conversion efficiency of various emission treatment devices.

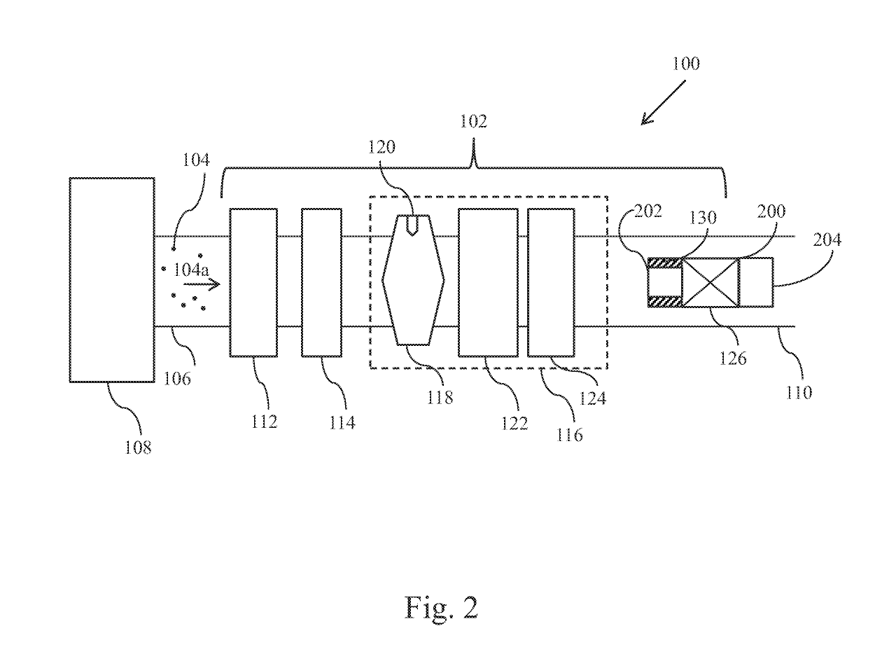

FIG. 2 illustrates an exemplary exhaust system 100 with the NOx sensor 126 according to one embodiment of the present disclosure. The system 100 is described in conjunction with the elements described in FIG. 1. In this embodiment, the NOx sensor 126 is shown with the AMOX catalyst 130. As shown in FIG. 2 the NOx sensor 126 can be housed inside an adapter 200. The adapter 200 includes an inlet pipe 202 and an outlet pipe 204. Both, the inlet and the outlet pipe (202 and 204 respectively) can be abutted to each other in the direction of flow of the exhaust gas stream 104. To ensure the oxidation of the residual ammonia in the exhaust gas stream 104, the inlet pipe 202 of the adapter 200 can be coated with the AMOX catalyst 130. The AMOX catalyst 130 can be provided upstream of the NOx sensor 126 to oxidize any unused ammonia before it reaches the NOx sensor 126. Other elements of the exhaust treatment system 102 are configured in the same manner as explained in FIG. 1.

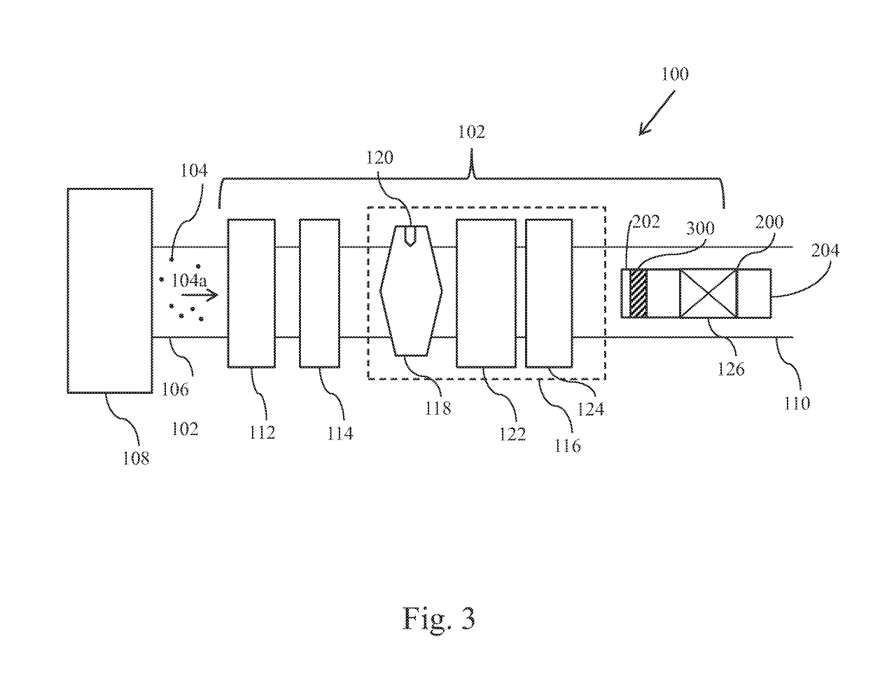

FIG. 3 illustrates an exemplary exhaust system 100 with the NOx sensor 126 according to one embodiment of the present disclosure. The system 100 is described in conjunction with the elements described in FIG. 1 and FIG. 2. In this embodiment the inlet pipe 202 of the adapter 200 includes the AMOX catalyst 130. In this embodiment, the AMOX catalyst 130 may be provided as a substrate 300. For example, the substrate 300 can be a coated honeycomb or metal mesh substrate. The exhaust gas stream 104 can be passed through the substrate 300 before it reaches the NOx sensor 126. The unused or the residual ammonia in the exhaust gas stream 104 may be oxidized upstream of the NOx sensor 126 and does not affect the dosing system 128. Other elements of the exhaust treatment system 102 are configured in the manner as explained in FIG. 1 and FIG. 2.

### INDUSTRIAL APPLICABILITY

The present disclosure applies generally to fossil fuel powered engines. The disclosed system may also be applied to diesel engines, electric power generation systems, DPF regeneration systems, or any suitable systems where ammonia slip can interfere with NOx measurement. The disclosed system finds specific applicability in diesel powered engines such as those found in marine vehicles, which show higher levels of ammonia slip (unused ammonia slipping downstream of SCR catalyst 122) or unstable dosing control system 128 due to ammonia slip. The exhaust treatment system 102 of the present disclosure allows for functioning of the dosing control system 128 of the SCR device 116, and accurate measurement of efficiency of various emission treatment devices. The exhaust treatment system 102 allows for the oxidation of the unused ammonia in the exhaust gas stream that can be slipped downstream the SCR catalyst 122, before it reaches the NOx sensor 126. Specifically, the exhaust treatment system 102 provides the AMOX catalyst 130 disposed upstream of the NOx sensor 126. The AMOX catalyst 130 can be provided as a coating on the NOx sensor 126. In another embodiment, the AMOX catalyst can be provided as coating inside a probe or inlet channel or inlet pipe 202 of an adapter 200 for the NOx sensor 126. In another embodiment, the AMOX catalyst 130 can be provided as substrate 300 in the exhaust gas inlet pipe for the NOx sensor 126. It can also be noted that both the optional and the AMOX catalysts (124 and 130 respectively) can be capable of converting the ammonia to diatomic nitrogen (N2).

In the foregoing specification, the disclosure and its benefits and advantages have been described with reference to specific embodiments. However, one of ordinary skill in the art would appreciate that various modifications and changes can be made without departing from the scope of the present disclosure, as set forth in the claims below. Accordingly, the specification and figures are to be regarded in an illustrative rather than a restrictive sense, and all such modifications are intended to be included within the scope of the present disclosure. The benefits, advantages, solutions to problems, and any element(s) that may cause any benefit, advantage or solution to occur or become more pronounced are not to be construed as critical, required or essential features or elements of any or all the claims. The disclosure is defined solely by the appended claims, including any amendments made during the pendency of this application, and all equivalents of those claims, as issued.

What is claimed is:

1. An exhaust treatment system, comprising:
a mixing tube configured to mix an exhaust gas stream with a reductant and facilitate decomposition of the reductant into ammonia;
a selective reduction catalyst disposed downstream of the mixing tube and configured to reduce oxides of nitrogen using the ammonia; and
an adapter disposed downstream of the selective reduction catalyst, the adapter comprising an inlet pipe and an outlet pipe, wherein both the inlet pipe and the outlet pipe are abutted to each other and disposed in a direction of flow of the exhaust gas stream; and
a sensor configured to measure an amount of oxides of nitrogen in the exhaust gas stream, wherein the sensor is disposed between the inlet pipe and the outlet pipe,
wherein the sensor is coated with an ammonia oxidation catalyst configured to oxidize the ammonia present in the exhaust gas stream upstream of the sensor before the exhaust gas stream reaches the sensor.

2. An exhaust treatment system, the system comprising:
a catalytic oxidation device configured to oxidize hydrocarbons and oxides of carbon and nitrogen in an exhaust gas stream;
a particulate trap configured to remove one or more types of particulate matter from the exhaust gas stream;
a mixing tube configured to mix the exhaust gas stream with a reductant and facilitate decomposition of the reductant into ammonia;
a selective reduction catalyst disposed downstream of the mixing tube and configured to reduce oxides of nitrogen using the ammonia;
an adapter disposed downstream of the selective reduction catalyst, the adapter comprising an inlet pipe and an outlet pipe, wherein both the inlet pipe and the outlet pipe are abutted in the direction of flow of the exhaust gas stream; and
a sensor configured to determine an amount of oxides of nitrogen in the exhaust gas stream, wherein the sensor is disposed between the inlet pipe and an the outlet pipe,
wherein the inlet pipe of the adapter is coated with an ammonia oxidation catalyst configured to oxidize the ammonia present in the exhaust gas stream upstream of the sensor.

3. An exhaust treatment system, the system comprising:
a catalytic oxidation device configured to oxidize hydrocarbons and oxides of carbon and nitrogen in an exhaust gas stream;
a particulate trap configured to remove one or more types of particulate matter from the exhaust gas stream;
a mixing tube configured to mix the exhaust gas stream with a reductant and facilitate decomposition of the reductant into ammonia;
a selective reduction catalyst disposed downstream of the mixing tube, configured to reduce oxides of nitrogen using the ammonia;
an adapter disposed downstream of the selective reduction catalyst, the adapter comprising an inlet pipe and an outlet pipe, wherein both the inlet pipe and the outlet pipe are abutted in the direction of flow of the exhaust gas stream; and
a sensor configured to measure an amount of oxides of nitrogen in the exhaust gas stream, wherein the sensor is disposed between the inlet pipe and the outlet pipe,
wherein the inlet pipe of the adapter comprises a substrate coated with an ammonia oxidation catalyst configured to oxidize the ammonia present in the exhaust gas stream upstream of the sensor.
